(19) United States
(12) Patent Application Publication
(10) Pub. No.: US 2016/0063577 A1
(43) Pub. Date: Mar. 3, 2016

(54) HANDLING OF REAL-TIME ADVERTISEMENT WITH CONTENT PREFETCHING

(71) Applicant: TENSERA NETWORKS LTD., Adanim (IL)

(72) Inventors: Daniel Yellin, Ra'anana (IL); David Ben Eli, Modiin (IL); Roee Peled, Givatayim (IL)

(21) Appl. No.: 14/821,747

(22) Filed: Aug. 9, 2015

Related U.S. Application Data
(60) Provisional application No. 62/042,262, filed on Aug. 27, 2014.

(51) Int. Cl. G06Q 30/02; G06F 15/167

(52) U.S. Cl. CPC G06Q 30/0277; G06F 15/167

(57) ABSTRACT

A method includes prefetching advertisement items from one or more advertisement sources over a network to an advertisement cache of a user terminal. In response to an indication that a content item is expected to be consumed by the user terminal, a request for an advertisement item to be presented in association with the content item is sent from the user terminal over the network. An instruction to present a selected advertisement item is received in the user terminal in response to the request. If the selected advertisement item is available in the advertisement cache, the selected advertisement item is retrieved from the advertisement cache, and the retrieved advertisement item is presented in association with the content item.

### CROSS-REFERENCE TO RELATED APPLICATIONS

This application claims the benefit of U.S. Provisional Patent Application 62/042,262, filed Aug. 27, 2014, whose disclosure is incorporated herein by reference.

### FIELD OF THE INVENTION

The present invention relates generally to content delivery, and particularly to methods and systems for handling of real-time advertisement with content prefetching.

### BACKGROUND OF THE INVENTION

Various techniques are known in the art for delivering content to wireless users. For example, U.S. Pat. No. 8,601,052, whose disclosure is incorporated herein by reference, describes a method and system for performing content prefetching for a wireless portable computing device (PCD).

As another example, U.S. Patent Application Publication 2010/0161831, whose disclosure is incorporated herein by reference, describes a content and traffic managing system. A mobile device is connectable to users and to content providers via communication links. The system tracks various parameters over time, and schedules communication in relation to predefined or projected content responsive to user content-related behavior, user communication behavior, user external behavior, and parameters of communication links.

Some content delivery schemes involve delivering advertisements. For example, U.S. Patent application Publication 2014/0279026, whose disclosure is incorporated herein by reference, describes techniques for prefetching advertisements for mobile advertising. A prediction model for estimating a number of advertisements that a mobile client is likely to request during an upcoming prediction time period can be employed. An estimated total amount of time of likely interaction with application executed by the mobile client can be predicted. Based upon such prediction, a number of advertisement slots likely to be available and a probability of each of the advertisement slots being available can be computed. An ad server can allocate advertisements in a pending advertisement queue and/or disparate advertisements collected from an ad exchange to the mobile client based upon the number of advertisement slots likely to be available, the probability of each of the advertisements slots being available, and aggregated probabilities of the pending advertisements in the pending advertisement queue being displayed prior to corresponding deadlines for expiration.

### SUMMARY OF THE INVENTION

An embodiment of the present invention that is described herein provides a method including prefetching advertisement items from one or more advertisement sources over a network to an advertisement cache of a user terminal. In response to an indication that a content item is expected to be consumed by the user terminal, a request for an advertisement item to be presented in association with the content item is sent from the user terminal over the network. An instruction to present a selected advertisement item is received in the user terminal in response to the request. If the selected advertisement item is available in the advertisement cache, the selected advertisement item is retrieved from the advertisement cache, and the retrieved advertisement item is presented in association with the content item.

In some embodiments, the method includes prefetching content items from one or more content sources to a content cache of the user terminal, and the content item that is expected to be consumed is one of the prefetched content items in the content cache. In an embodiment, receiving the instruction to present the selected advertisement includes receiving an outcome of an advertisement auction conducted for the content item, or of a direct sale of ad space on the content item.

In a disclosed embodiment, prefetching the advertisement items includes identifying one or more candidate advertisement items that are predicted to be selected for presentation to a user of the user terminal, and prefetching the candidate advertisement items. Identifying the candidate advertisement items may include identifying one or more of the advertisement items that are accessed with highest frequencies in the user terminal.

In an embodiment, prefetching the advertisement items includes choosing the advertisement items for prefetching based on a memory size available for the advertisement cache. In another embodiment, prefetching the advertisement items includes receiving the advertisement items by communicating with the advertisement sources. In an embodiment, the method includes, when connectivity to the network is unavailable to the user terminal, retrieving advertisement items only from the advertisement cache. In an embodiment, the method includes recording in the user terminal information regarding consumption of the advertisement items while the connectivity to the network is unavailable, and reporting the information after the connectivity to the network is resumed.

There is additionally provided, in accordance with an embodiment of the present invention, a system including a network interface for communicating over a network, and one or more processors. The one or more processors are configured to prefetch advertisement items from one or more advertisement sources over the network to an advertisement cache of a user terminal, to send from the user terminal over the network, in response to an indication that a content item is expected to be consumed by the user terminal, a request for an advertisement item to be presented in association with the content item, to receive in the user terminal an instruction to present a selected advertisement item in response to the request, and, if the selected advertisement item is available in the advertisement cache, to retrieve the selected advertisement item from the advertisement cache and to present the retrieved advertisement item in association with the content item.

There is also provided, in accordance with an embodiment of the present invention, a user terminal including a memory and a processor. The memory is configured to hold an advertisement cache. The processor is configured to prefetch advertisement items from one or more advertisement sources over a network to the advertisement cache, to send over the network, in response to an indication that a content item is expected to be consumed by a user of the user terminal, a request for an advertisement item to be presented in association with the content item, to receive an instruction to present a selected advertisement item in response to the request, and, if the selected advertisement item is available in the advertisement cache, to retrieve the selected advertisement item from the advertisement cache and to present the retrieved advertisement item in association with the content item.

There is further provided, in accordance with an embodiment of the present invention, a computer software product, the product including a tangible non-transitory computer-readable medium in which program instructions are stored, which instructions, when read by one or more processors, cause the one or more processors to prefetch advertisement items from one or more advertisement sources over a network to an advertisement cache of a user terminal, to send from the user terminal over the network, in response to an indication that a content item is expected to be consumed by the user terminal, a request for an advertisement item to be presented in association with the content item, to receive in the user terminal an instruction to present a selected advertisement item in response to the request, and, if the selected advertisement item is available in the advertisement cache, to retrieve the selected advertisement item from the advertisement cache and to present the retrieved advertisement item in association with the content item.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a content delivery system, in accordance with an embodiment of the present invention;

FIG. 2 is a block diagram that schematically illustrates an advertisement prefetch control unit, in accordance with an embodiment of the present invention; and

FIG. 3 is a flow chart that schematically illustrates a method for content and advertisement prefetching, in accordance with an embodiment of the present invention.

### DETAILED DESCRIPTION OF EMBODIMENTS

### Overview

Embodiments of the present invention that are described herein provide improved methods and systems for handling advertisements in conjunction with content prefetching. In particular, although not exclusively, the disclosed techniques enable efficient integration of content pre-fetching and real-time advertisement (“ad”) bidding or auctioning.

In a typical real-time ad bidding process, ad space on Web pages is regarded as “real estate” that is auctioned by ad brokers among multiple ad providers. The bidding process is performed in real-time or semi-real-time, after the user has requested to view the page. The rationale behind the real-time nature of this process is that the auction depends on time-varying parameters such as the user location, the time-of-day, or various time-varying advertiser preferences.

Real-time ad bidding poses a considerable challenge to content prefetching schemes. When using content prefetching, Web pages are fetched to a cache of the user terminal before the user actually requests them, in order to reduce the delay between requesting and displaying the pages. One naive way to integrate real-time ad bidding into a content prefetching scheme would be to conduct the auction in response to the user requesting a page that has been prefetched. In this solution, however, the latency gained by content prefetching would be lost due to the time needed for bidding and delivering the winning ad.

Embodiments of the present invention overcome the above-described challenge, and provide a solution that retains the real-time nature of real-time ad bidding, and at the same time retains the small-latency and high-quality user experience of content prefetching.

In some disclosed embodiments, a prefetching subsystem comprises a Content Prefetching Control unit (CPC) and an Ad Prefetching Control unit (APC). The CPC prefetches content items such as Web pages to a content cache of the user terminal. The APC prefetches selected ad items, to be presented in association with content items, to an ad cache in the user terminal.

When the user requests a content item for consumption (e.g., viewing), the user terminal may notify the APC of this content item if it wishes to add an ad to it. The APC notifies the ad broker, which in turn carries out a conventional real-time ad auction for the ad space on the content item in question. The winning ad, or a link thereto, is provided to the APC or directly to the user terminal.

If the APC or user terminal finds that the winning ad is available in the terminal's ad cache, the ad is served locally from the cache. In such a case, the latency from requesting to presenting the content item is kept small. Otherwise, the ad is fetched from the appropriate ad source, and the content item is therefore presented after a longer delay. If both the content item and the winning ad are available in the cache, the end-to-end latency is minimal.

In the description above, the ad auction (or other form of ad selection or assignment) for a content item is conducted in response to the user requesting to actually consume that content item. In alternative embodiments, the system triggers an ad auction (or other form of ad selection or assignment) for a content item as soon as the content item is prefetched, or at any other suitable point in time between the time the content item is prefetched and the time the user requests to consume it. In such embodiments, the system may indicate to the ad broker when the user is expected to view the winning ad, and the confidence level of this expectation. Such information may be taken into account in the auctioning process.

As can be appreciated from the above description, the overall performance of the disclosed technique depends on the probability of “cache hit,” i.e. the likelihood that an ad that wins the real-time auction has been already prefetched to the terminal's ad cache. Various techniques and heuristics for choosing ads for prefetching are described herein. Various system configurations, e.g., implementations of the APC functionality on the network side and/or on the user terminal side, are also described.

### System Description

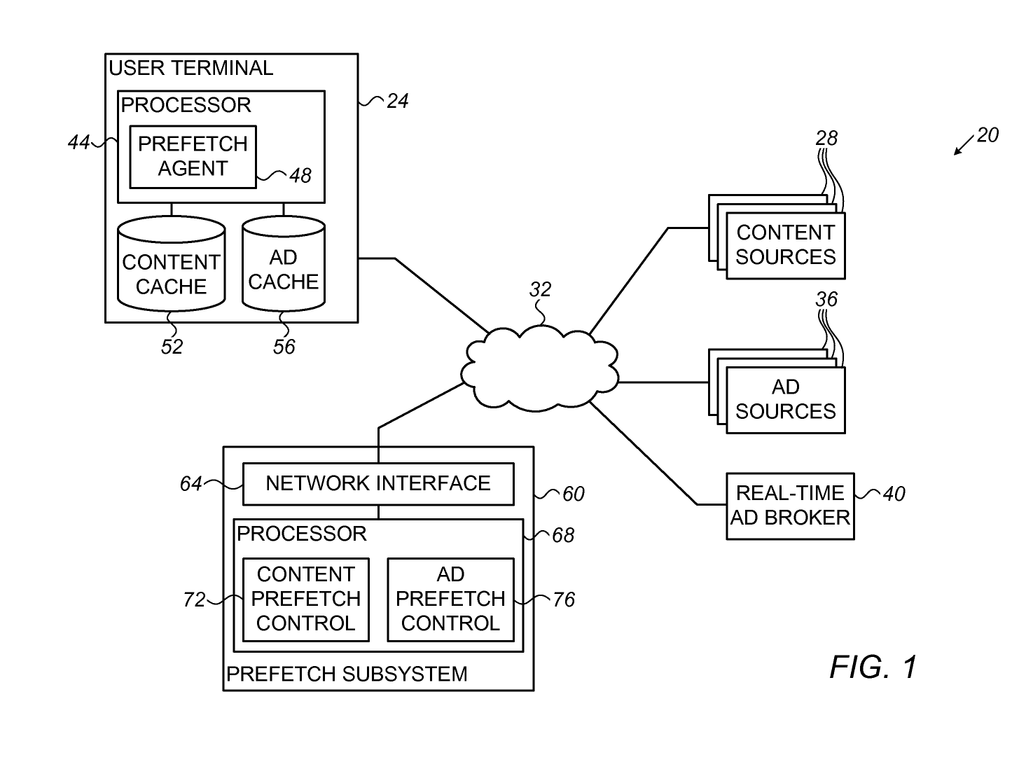

FIG. 1 is a block diagram that schematically illustrates a content delivery system 20, in accordance with an embodiment of the present invention. The configuration of system 20 is one example configuration. Several alternative configurations are described further below.

System 20 comprises a user terminal 24 that accesses and consumes content items provided by one or more content sources 28 over a network 32. Terminal 24 may comprise any suitable wireless or wireline terminal, such as, for example, a cellular phone or smart-phone, a wireless-enabled laptop or tablet computer, a desktop personal computer, or any other suitable type of user terminal that is capable of communicating over a network and presenting content to a user. User terminal 24 may consume content using any suitable software, e.g., a browser or dedicated application. The figure shows a single terminal 24 for the sake of clarity, but real-life systems typically comprise a large number of user terminals of various kinds.

Network 32 may comprise, for example, the Internet, a Local Area Network (LAN), a wireless network such as a cellular network or Wireless LAN (WLAN), or any other suitable network or combination of networks.

Content sources 28 may comprise, for example, Web content servers, or any other suitable sources of content. The description that follows refers mainly to delivery of Web pages. The disclosed techniques, however, can be used with any other suitable types of content items, such as, for example, audio or video clips, html files, Java scripts and/or CSS files, to name just a few examples.

At least some of the content items consumed by user terminals 24 have ad space, i.e., are provisioned to display embedded advertisements. The decisions as to which ad to display in which content items on which user terminal may be performed in real-time or in semi-real time. In the present example, ads are provided by one or more ad sources 36, e.g., ad servers. Ads are also referred to herein as “advertisement items.” A real-time ad broker 40 carries out real-time auctions among ad sources 36, for ad space on content items that are to be presented on user terminals 24. Ad broker 40 is sometimes also referred to as a real-time ad exchange.

In some embodiments, system 20 performs prefetching of both content items and ads using methods that are described in detail below. In the present example, user terminal 24 comprises a processor 44 that carries out the various processing tasks of the terminal. Among other tasks, processor 44 runs a software component referred to as a prefetching agent 48, which handles prefetching of content items and ads. In addition, user terminal 24 comprises a content cache 52 for caching prefetched content items, and an ad cache 56 for caching prefetched ads. Both caches are typically managed by agent 48. User terminal 24 typically also comprises a suitable network interface (not shown in the figure) for connecting to network 32. This network interface may be wired (e.g., an Ethernet Network Interface Card) or wireless (e.g., a cellular modem).

In the embodiment of FIG. 1, system 20 further comprises a prefetching subsystem 60 that performs the various content and ad prefetching tasks on the network side. Subsystem 60 comprises a network interface 64 for communicating over network 32, and a processor 68 that carries out the various processing tasks of the prefetching subsystem. In the present example, processor 68 runs a Content Prefetching Control unit (CPC) 72 and an Ad Prefetching Control unit (APC) 76 that carry out content and ad prefetching, respectively.

Certain aspects of content prefetching, and content prefetching schemes that can be used by subsystem 60 and agent 48, are addressed in U.S. patent application Ser. No. 14/691,597, which is assigned to the assignee of the present patent application and whose disclosure is incorporated herein by reference.

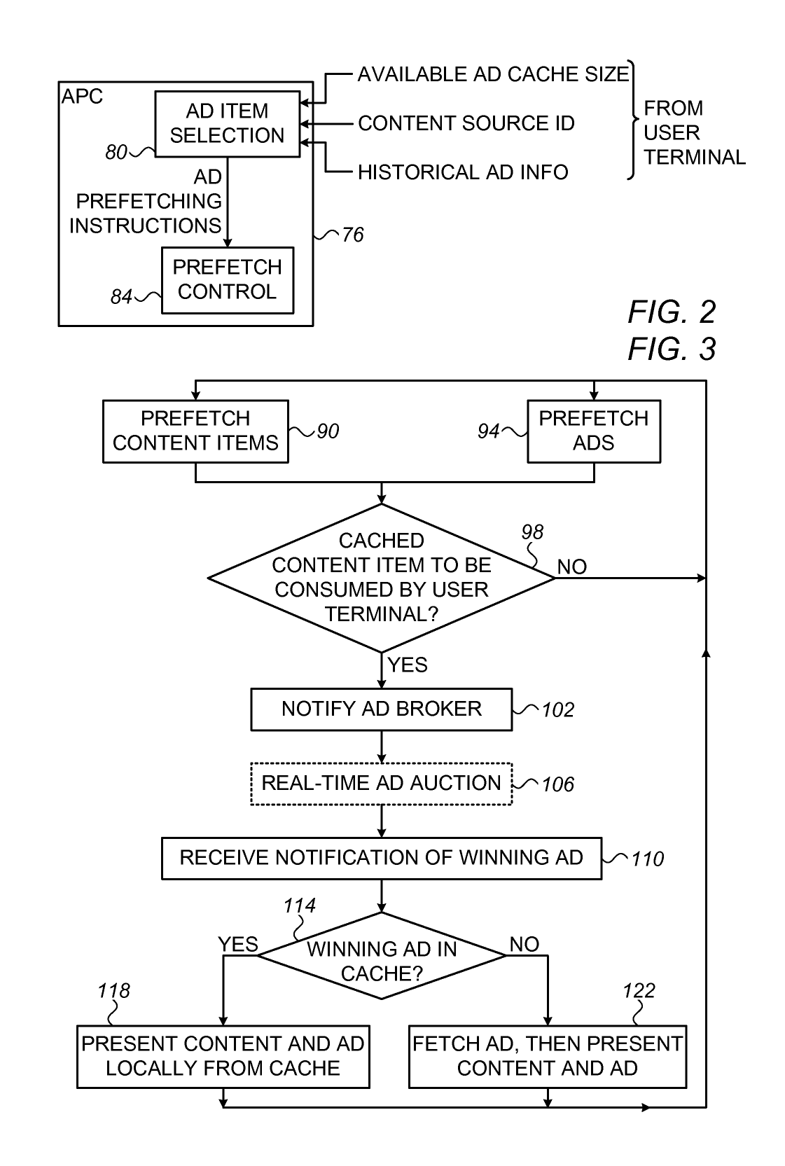

The configurations of system 20 and its various elements shown in FIGS. 1 and 2 are example configurations, which are chosen purely for the sake of conceptual clarity. In alternative embodiments, any other suitable configurations can be used. For example, the functions of prefetching subsystem 60 can be implemented using any desired number of processors, or even in a single processor. The various system functions can be partitioned among the processors in any suitable way. In another embodiment, some or all of the functions of subsystem 60 may be performed by agent 48 in user terminal 24. Examples of such configurations are described in greater detail below. Thus, in the context of the present patent application and in the claims, the disclosed techniques are carried out by one or more processors. The processors may reside in user terminal 24, and/or on the network side such as in subsystem 60, in content sources 28, ad sources 36 and/or ad broker 40.

Although the embodiments described herein refer mainly to human users, the term “user” refers to machine users, as well. Machine users may comprise, for example, various host systems that use wireless communication, such as in various Internet-of-Things (IoT) applications.

The different elements of system 20 may be implemented using suitable software, using suitable hardware, e.g., using one or more Application-Specific Integrated Circuits (ASICs) or Field-Programmable Gate Arrays (FPGAs), or using a combination of hardware and software elements. Caches 52 and 56 may be implemented using one or more memory or storage devices of any suitable type. In some embodiments, agent 48 and/or subsystem 60 may be implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Integrated Real-Time Advertising and Content Prefetching

As explained above, content prefetching and real-time ad bidding are processes that differ in nature and, unless accounted for, conflict with one another. Consider, for example, a certain content item that was prefetched and cached in content cache 52. In practice, the user may request to consume this content item a long time after it has been fetched, or may not request the content item at all. Therefore, in some cases it does not make sense to auction ad space on this content item at the time of prefetching. On the other hand, auctioning ad space on this content item in response to the user requesting to consume the content will add a considerable delay and offset the benefit gained by prefetching.

In some embodiments, APC 76 prefetches selected ads in advance from ad sources 36 to ad cache 56 of terminal 24, typically by communicating with agent 48. When the user of terminal 24 requests a content item, agent 48 sends APC 76 a message indicating the content item that is about to be presented to the user. APC 76 sends a corresponding notification to ad broker 40, and the ad broker auctions the ad space of the content item among the ad sources. An indication of the ad that won the auction is provided to APC 76 and/or agent 48.

If APC 76 or agent 48 finds that the winning ad is available in ad cache 56, agent 48 serves the ad locally from cache 56. This scenario is referred to as a “cache hit” and has very small latency in presenting the content item (with the winning ad embedded therein) to the user. In case of a “cache miss,” if the winning ad is not found in ad cache 56, APC 76 or agent 48 fetches the ad from the appropriate ad source. A cache-miss event thus results in higher latency in presenting the content item (with the winning ad) to the user.

When implementing the above process, several possible data flows can be used. In one embodiment, agent 48 communicates with APC 76, for receiving prefetched ads and winning ads. The APC may obtain the ads from ad sources 36 or from ad broker 40, and provide the ads to agent 48. In another embodiment, agent 48 may communicate directly (not via APC 76) with ad sources 36 or ad broker to receive ads. In another embodiment, agent 48 may communicate directly (not via APC 76) with content sources 28 to receive content items in which ads have already been embedded.

In some embodiments, predicted user parameters, e.g., parameters indicative of when the content will be consumed, could also be sent to ad sources 36 or ad broker 40, in order to allow better embedding of the right ads in the content. Such predicted user parameters may comprise, for example, the time-of-day at which the user is predicted to consume that content, the expected user location, and/or the confidence levels of these estimates as well as the confidence of the user actually consuming this content. Some of these data flows are addressed in greater detail below.

In other embodiments, the ad auction may not necessarily be real-time or even semi-real-time. In yet other embodiments, ad space on content items may be sold by the content publisher directly, without an ad broker. In such embodiments, ad space is typically sold for relatively long time durations (e.g., on the order of weeks), and therefore lend themselves for long-term prefetching and caching.

In an embodiment, each ad is assigned a respective identifier (ID). Following an ad auction, APC 76 may report to agent 48 the ID of the winning ad, and send a link (e.g., Uniform Resource Locator—URL to the storage location of the winning ad in network 32. The ads cached in ad cache 56 are also associated with respective IDs. Based on the reported ID of the winning ad, agent 48 may determine whether the winning ad is available in cache 56 or not, and act accordingly. In an embodiment, the link (e.g., URL) itself serves as the ID. In this case, it is typically sufficient to send the URL link once.

In various embodiments, APC 76 may use various selection criteria for deciding which ads to prefetch to ad cache 56. The selection criterion typically aims to maximize the cache-hit probability, i.e., the likelihood that an ad that wins the real-time auction has been previously prefetched to ad cache 56.

In one embodiment, APC 76 attempts to maximize the number of prefetched ads that are cached in ad cache 56. This approach is limited by the amount of memory space available in terminal 24 for allocation to the ad cache. This available amount of memory space may be time-varying. In some embodiments, APC 76 attempts to prefetch the ads that will maximize the cache-hit probability given the available memory size. In other words, APC 76 may attempt to predict which ads are most likely to win real-time auctions for the content items consumed by the particular terminal 24, and prefetch these ads.

In one example embodiment, APC 76 may prefetch the most popular ads, e.g., the ads that most frequently won real-time auctions in some predefined past time period. As another example, ad broker 40 may occasionally define a list of ads to be prefetched, and APC 76 may prefetch the ads on the list. The ad broker may specify this list separately per user terminals 24 and/or per content source 28.

In other embodiments, the functionality of selecting which ads to cache is carried out by agent 48 in the user terminal, not by APC 76. In an example embodiment, agent 48 may select which ads to cache in cache 56 and which ads to discard, based on the usage frequencies of the ads. In this embodiment, agent 48 will give higher priority to caching frequently-used ads over rarely-used ads. Rarely-used ads are therefore more likely to be evicted from cache 56 when the cache becomes full. Thus, at least logically, agent 48 may manage content cache 52 and ad cache 56 as two separate caches, with different caching and eviction criteria.

In the latter embodiment, ads cached by agent 48 may have been prefetched, or they may have been fetched on demand. In either case, agent 48 caches them for possible consumption with subsequent content items that have not yet been requested by the user. Therefore, this type of caching is also regarded as prefetching of ads.

FIG. 2 is a block diagram that schematically illustrates APC 76, in accordance with an embodiment of the present invention. In this example, APC 76 comprises an ad selection module 80 and a prefetch control module 84. Module 80 receives from user terminal 24 (typically from agent 48) information such as the memory space that is currently available for caching ads, and historical usage data per ad (e.g., per ad ID). This information may be provided per content source.

Module 80 accumulates this information over time, and produces an empirical likelihood per ad ID. The empirical likelihood of an ad is indicative of the likelihood of this ad to be presented. In other words, the empirical likelihood of an ad predicts the likelihood of this ad to win future real-time ad auctions for display in the specific user terminal. The likelihood may change per given time, location, or other parameters.

In one embodiment, module 80 estimates the empirical likelihood for a given ad by estimating the usage frequency of the ad. For example, module 80 may count the number of times that this ad was presented to the user, and divide this number by the total number of consumed ads in a given period of time.

In some embodiments, agent 48 provides the historical ad usage information to module 80 along with an identifier (ID) of the relevant content source (e.g., Web portal). The content source ID may comprise, for example, a hostname, URL or any other suitable ID. Using the content source IDs, module 80 is able to estimate the empirical likelihood separately per each content source visited by the user. This information enables, for example, matching of the prefetching policy to the user's specific content usage patterns. For example, if a user visits a certain Web portal much more frequently than other portals, the advertisement content of that portal would be preferred. In other words, the usage frequency is calculated globally over all relevant Web portals, which will inherently prioritize ads related to more frequently-used portals. In an alternative embodiment, module 80 may calculate the empirical likelihood separately per content source (e.g., portal), and memory in terminal 24 is also allocated separately per content source.

As noted above, agent 48 may also notify module 80 of the available memory space for caching ads, i.e., the available size of cache 56. This memory space may be time varying, e.g., when the total memory space for prefetching of both content and ads is fixed but the prefetched content size changes over time.

Based on the above-described information, and/or any other suitable information, module 80 selects which ads are the best candidates for prefetching, and delivers the IDs of the selected ads to prefetch control module 84. Module 84 is responsible for prefetching the selected ads from ad sources 36 to cache 56 in terminal 24. When a certain ad that was previously prefetched is to be presented to the user (i.e., upon a cache hit), module 84 sends agent 48 the ID of this ad, instructing agent 48 which ad to present. In case of a cache miss, module 84 typically downloads the ad, in real-time, from the appropriate ad source to terminal 24.

In an alternative embodiment, APC 76 sends only ad IDs to terminal 24, and does not handle the actual prefetching of the ads. In this embodiment, APC 76 notifies agent 48 of the ID of the ad that is to be presented with a given content item (e.g., the ID of the ad that won a real-time auction). Agent 48 serves the ad from cache 56 if the ad has been prfetched, or fetches the ad from the appropriate ad source otherwise. This implementation typically exhibits smaller latency.

As noted above, APC 76 may not necessarily be implemented as a separate server or network node. For example, the functionality of APC 76 may be implemented in user terminal 24, in a content source 28 (e.g., Web portal), in an ad source 36, at ad broker 40, or distributed among two or more of these entities. In one embodiment, ad selection module 80 is implemented in user terminal 24, and prefetch control module 84 is implemented in an ad source 36 or in ad broker 40. In this configuration, upon a cache hit, prefetch control module 84 sends terminal 24 only a small packet containing an ID or pointer to the desired ad, rather than the ad itself. This implementation is especially advantageous in relatively slow, bandwidth-limited networks such as cellular networks.

In an alternative embodiment, prefetch control module 84 may be implemented in a separate network node, e.g., a dedicated server. In this implementation, the ad should be transferred from ad source 36 to module 84, but this transfer is typically performed over a relatively fast wired Internet connection. The potentially slow and low-bandwidth wireless path from the module 84 to terminal 24 is still avoided in the majority of cases, upon cache hits.

In yet another embodiment, APC 76 is implemented entirely in terminal 24, e.g., as part of agent 48. In this implementation, upon a cache hit, the APC may be able to eliminate the latency of prefetching the relevant ad again. In an embodiment, the APC may inspect the beginning of the transmitted ad. Quite often, there is a unique content descriptor in the form of a header or a specific URL at the beginning of the ad, and this descriptor allows identification of the content before it is fully received. Using the descriptor, module 84 (implemented in terminal 24 in this example) may uniquely identify the ad quickly, and eliminate most of the latency associated with full reception.

FIG. 3 is a flow chart that schematically illustrates a method for content and advertisement prefetching, in accordance with an embodiment of the present invention. The method begins with CPC 72 prefetching content items from one or more content sources 28 to content cache 52 of user terminal 24, at a content prefetching step 90. APC 76 prefetching advertisement items from one or more ad sources 36 to ad cache 56 of user terminal 24, at an ad prefetching step 94.

At a consumption checking step 98, agent 48 in the user terminal checks whether a content item that has been prefetched and cached is about to be consumed, i.e., presented to the user. If so, agent 48 notifies ad broker of the content item to be consumed, at a broker notification step 102.

In response to the notification, ad broker 40 conducts a real-time auction for the ad space on the content item that is about to be consumed, at a bidding step 106. Ad broker 40 notifies agent 48 of the winning ad, i.e., the ad that won the auction and should therefore be presented with the content item, at a winning ad notification step 110.

Agent 48 in user terminal 24 checks whether the winning ad is cached in advertisement cache 56, at a cache checking step 114. If the winning ad has been previously prefetched and is available in the cache, agent 48 serves the ad locally from ad cache 56, at a cached ad consumption step 118. In other words, agent 48 retrieves the winning ad from cache 56, and presents the ad in association with the content item.

Otherwise, i.e., if the winning ad is not available in cache 56, agent 48 fetches the ad over the network (e.g., from the APC, ad broker or ad source), and only then presents the ad in association with the content item, at a fetching and consumption step 122.

The description of FIG. 3 refers to prefetching of both content items and ads. Generally, however, the content and ads are independent, and any one of them may be served from the cache or retrieved over the network. For example, a content item may be retrieved over the network (not prefetched), while the corresponding ad is served from the cache. As another example, a content item may be prefetched and served from the cache, while the corresponding ad is retrieved over the network.

In the embodiments described herein, an ad may be presented before, at the same time as, or after the corresponding content item. For example, if a content item is available for presentation, it is possible to present it without waiting until the corresponding ad is also available. Similarly, if a content item arrives later than the corresponding ad, it is possible to present the ad first without waiting for the content item to arrive. All these variants, as well as any other suitable variant, are regarded as “presenting an ad in association with a content item.”

When carrying out the method of FIG. 3, system 20 typically bills the advertiser only for ads that are actually consumed, not for all ads that are prefetched. In an example embodiment, each content source 28 monitors the actual consumption of its content items, and does not charge ad broker 40 for ads that were not consumed. In particular, the ad broker is not charged for ads that were prefetched but not consumed.

For example, the charging policy is often based on clicks, i.e., the advertiser is charged only if the user clicks on the advertisement. Such click-based billing avoids the need to monitor whether the prefetched advertisement was consumed or not, and therefore simplifies the implementation. In the case where charging is based on impressions, i.e., ads are charged if they are displayed, only displayed ads would be regarded as consumed and charged.

In the embodiments described above, ad broker 40 auctions the ad space on a content item in real-time, in response to an indication that the content item is about to be consumed by the user terminal. In alternative embodiments, however, the auction may take place when the content item is prefetched in the first place, and not necessarily in real-time. For example, some advertisers are insensitive to the specific time-of-day at which their advertisements are being presented, and will therefore not be affected by the time difference between the auction and the actual content consumption. In such a case, system 20 may prefetch both the content item and the winning ad at the same time. As explained above, measures should be taken to charge only for ads that were actually consumed.

Alternatively, the APC 76 may send predictive parameters to allow better auctioning of ads. Such parameters may include the predicted times at which the ads would be displayed, the predicted user locations, and the expected accuracies of these predictions.

In the description above, the ad auction (or other form of ad selection or assignment) for a content item is conducted in response to the user requesting to actually consume that content item. In alternative embodiments, prefetching subsystem 60 may trigger an ad auction (or other form of ad selection or assignment) for a content item as soon as the content item is prefetched, or at any other suitable point in time between the time the content item is prefetched and the time the user requests to consume it.

For example, agent 48 may notify ad broker 40 that a certain content item has been prefetched to cache 52, i.e., that the content item is expected to be consumed at some future time. In response to this notification, ad broker 40 may conduct an ad auction for the content item, and report the winning ad to agent 48. Such an auction is tentative, because there is some probability that the content item, and therefore the winning ad, will not be actually presented to the user. In these embodiments, the prefetching subsystem may indicate to the ad broker when the user is expected to view the winning ad, and the confidence level of this expectation. This information may be taken into account in the auctioning process.

The methods described above could also be applied in situations in which terminal 24 has no network connectivity. This feature allows presenting ads even in extreme network conditions. Agent 48 may be configured to use only pre-fetched ads when it is reported that no network connectivity is available. In such embodiments, agent 48 may record the information regarding ad consumption, and report this information when network connectivity is resumed. This technique is advantageous, for example, when the publisher sells the ad space, and the ads are fixed or only selected from a small finite set, which can be done by the agent 48 as well. In this case there is no need to approach the ad broker, which may be problematic if connectivity is problematic.

Although the embodiments described herein mainly address integration of prefetched content and prefetched ads, the disclosed techniques can also be used in situations in which the content is not prefetched but rather always fetched on demand. Consider, for example, a video clip that is streamed on-demand and has ad space in its beginning. If the ad to be presented at the beginning of the clip has been prefetched using the disclosed techniques, the user terminal may be able to play the ad immediately in response to the user's request to view the clip, and in parallel retrieve the video content. This technique reduces latency and improves user experience.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
prefetching advertisement items from one or more advertisement sources over a network to an advertisement cache of a user terminal;
in response to an indication that a content item is expected to be consumed by the user terminal, sending from the user terminal over the network a request for an advertisement item to be presented in association with the content item;
receiving in the user terminal an instruction to present a selected advertisement item in response to the request; and
if the selected advertisement item is available in the advertisement cache, retrieving the selected advertisement item from the advertisement cache and presenting the retrieved advertisement item in association with the content item.

2. The method according to claim 1, further comprising prefetching content items from one or more content sources to a content cache of the user terminal, wherein the content item that is expected to be consumed is one of the prefetched content items in the content cache.

3. The method according to claim 1, wherein receiving the instruction to present the selected advertisement comprises receiving an outcome of an advertisement auction conducted for the content item, or of a direct sale of ad space on the content item.

4. The method according to claim 1, wherein prefetching the advertisement items comprises identifying one or more candidate advertisement items that are predicted to be selected for presentation to a user of the user terminal, and prefetching the candidate advertisement items.

5. The method according to claim 4, wherein identifying the candidate advertisement items comprises identifying one or more of the advertisement items that are accessed with highest frequencies in the user terminal.

6. The method according to claim 1, wherein prefetching the advertisement items comprises choosing the advertisement items for prefetching based on a memory size available for the advertisement cache.

7. The method according to claim 1, wherein prefetching the advertisement items comprises receiving the advertisement items by communicating with the advertisement sources.

8. The method according to claim 1, and comprising, when connectivity to the network is unavailable to the user terminal, retrieving advertisement items only from the advertisement cache.

9. The method according to claim 8, and comprising, while the connectivity to the network is unavailable, recording in the user terminal information regarding consumption of the advertisement items, and reporting the information after the connectivity to the network is resumed.

10. A system, comprising:
a network interface for communicating over a network; and
one or more processors, configured to prefetch advertisement items from one or more advertisement sources over the network to an advertisement cache of a user terminal, to send from the user terminal over the network, in response to an indication that a content item is expected to be consumed by the user terminal, a request for an advertisement item to be presented in association with the content item, to receive in the user terminal an instruction to present a selected advertisement item in response to the request, and, if the selected advertisement item is available in the advertisement cache, to retrieve the selected advertisement item from the advertisement cache and to present the retrieved advertisement item in association with the content item.

11. The system according to claim 10, wherein the one or more processors are further configured to prefetch content items from one or more content sources to a content cache of the user terminal, and wherein the content item that is expected to be consumed is one of the prefetched content items in the content cache.

12. The system according to claim 10, wherein the instruction to present the selected advertisement comprises an outcome of an advertisement auction conducted for the content item, or of a direct sale of ad space on the content item.

13. The system according to claim 10, wherein the one or more processors are configured to identify one or more candidate advertisement items that are predicted to be selected for presentation to a user of the user terminal, and to prefetch the candidate advertisement items.

14. The system according to claim 13, wherein the one or more processors are configured to identify the candidate advertisement items by identifying one or more of the advertisement items that are accessed with highest frequencies in the user terminal.

15. The system according to claim 10, wherein the one or more processors are configured to choose the advertisement items for prefetching based on a memory size available for the advertisement cache.

16. The system according to claim 10, wherein the one or more processors are configured to receive the advertisement items by communicating with the advertisement sources.

17. The system according to claim 10, wherein, when connectivity to the network is unavailable to the user terminal, the one or more processors are configured to retrieve advertisement items only from the advertisement cache.

18. The system according to claim 17, wherein the one or more processors are configured to record in the user terminal information regarding consumption of the advertisement items while the connectivity to the network is unavailable, and to report the information after the connectivity to the network is resumed.

19. A user terminal, comprising:
a memory, which is configured to hold an advertisement cache; and
a processor, which is configured to prefetch advertisement items from one or more advertisement sources over a network to the advertisement cache, to send over the network, in response to an indication that a content item is expected to be consumed by a user of the user terminal, a request for an advertisement item to be presented in association with the content item, to receive an instruction to present a selected advertisement item in response to the request, and, if the selected advertisement item is available in the advertisement cache, to retrieve the selected advertisement item from the advertisement cache and to present the retrieved advertisement item in association with the content item.

20. The user terminal according to claim 19, wherein the memory is further configured to hold a content cache, and wherein the processor is further configured to prefetch content items from one or more content sources to the content cache.

21. The user terminal according to claim 19, wherein the processor is configured to identify one or more candidate advertisement items that are predicted to be selected for presentation to a user of the user terminal, and prefetching the candidate advertisement items.

22. A computer software product, the product comprising a tangible non-transitory computer-readable medium in which program instructions are stored, which instructions, when read by one or more processors, cause the one or more processors to prefetch advertisement items from one or more advertisement sources over a network to an advertisement cache of a user terminal, to send from the user terminal over the network, in response to an indication that a content item is expected to be consumed by the user terminal, a request for an advertisement item to be presented in association with the content item, to receive in the user terminal an instruction to present a selected advertisement item in response to the request, and, if the selected advertisement item is available in the advertisement cache, to retrieve the selected advertisement item from the advertisement cache and to present the retrieved advertisement item in association with the content item.
